(19) United States
(12) Patent Application Publication
(10) Pub. No.: US 2008/0244582 A1
(43) Pub. Date: Oct. 2, 2008

(54) WEB-Based Task Management System and Method

(76) Inventors: William E. Brown, Bellevue, WA (US); Jason S. Astorquia, Seattle, WA (US); Todd W. Jones, Duvall, WA (US); Todd A. Fasullo, Seattle, WA (US); John D. Creason, Woodinville, WA (US); Mark P. Mader, Seattle, WA (US); Maria R. Frei, Bellevue, WA (US); Brent R. Frei, Bellevue, WA (US)

Correspondence Address: CENTRAL COAST PATENT AGENCY, INC, 3 HANGAR WAY SUITE D, WATSONVILLE, CA, 95076, US

(21) Appl. No.: 12/058,605

(22) Filed: Mar. 28, 2008

Related U.S. Application Data
(60) Provisional application No. 60/909,417, filed on Mar. 31, 2007.

(51) Int. Cl. G06F 9/46

(52) U.S. Cl. 718/100

(57) ABSTRACT

A task management system and method integrates rich functionality into a web-browser based application. An efficient request for an update enables a user to quickly generate a completely customizable email message to intended recipient(s). By introducing a client side, in-memory database, the client component becomes less susceptible to network connectivity glitches and enables user interfaces to be redrawn without server interaction. Additionally, the task management system and method provides flexibility by enabling tasks to be grouped and organized. Specifically, a task may be associated with multiple task sheets and a task sheet may include multiple tasks in a many-to-many manner. Also, templates may be created that enable a user to start with a base template and to add (or remove) one or more columns. Further, the task management systems allows for multiple users to access and manipulate task data concurrently. In addition, the task management system provides a means for viewing the change history of task data within a task sheet by highlighting task data within a task sheet that has been changed by another user of the task management system.

### CROSS-REFERENCE TO RELATED APPLICATIONS

The present invention claims priority to a U.S. provisional patent application Ser. No. 60/909,417 filed on Mar. 31, 2007, disclosure of which is incorporated in its entirety at least by reference.

### BACKGROUND OF THE INVENTION

1. Field of the Invention

The present invention is in the field of task and workflow management, and relates more particularly to web-based system for managing tasks with a web browser using task sheets.

2. Discussion of the State of the Art

A problem exists in the art of workflow management regarding management of projected-related tasks, wherein multiple users need to access a project plan, provide updates to given tasks, and correlate all information in a common format with easy accessibility.

Project management systems are well-known in the art. Microsoft Project™ is notably one among many that allow a user to create a project plan, associate tasks and sub-tasks with that project plan and assign resources to perform a given task. Microsoft Project™ and similar products are known in the art as “installed application solutions”, wherein the application is installed on a client device, or perhaps more typically on a number of different client devices).

Existing systems in the art are typically limited in ease of accessibility and ease of use. For example, when using installed application solutions a first user (the “originator”) creates a project file. To receive input on this file from other persons, the originator must e-mail or otherwise provide this electronic file to the recipients so that the recipients can load the file in their local application. This method assumes that each recipient has the installed application on their machine to properly load, edit and save the file. Additionally, this model is limited in that when more than one person edits the same project separately, concurrency problems are created. Reconciling multiple updates creates a time consuming version management issue that must be resolved each time changes are made by multiple users.

Moving a task management application from the desktop as an installed application to a centralized location as a Web application provides many advantages relating to concurrency between multiple users. However, many Web applications lack a rich user interface of installed applications, making them impractical applications for demanding users. In particular, the multiple form-based model of many web applications is too time consuming for applications that involve extensive data operations, requires the user to navigate through one or more interfaces, and makes an application particularly sensitive to network connectivity problems.

Further to the above, existing systems do not provide for a sufficiently flexible system of associating or grouping tasks. For example, although tasks may be grouped (e.g., assigning a task to a task group), it may not be possible to assign a single task to multiple groups.

Also in addition to the above, existing systems often require users to format data per application limitations. For example, a user may add or delete fields to present data, but often cannot reassign the underlying representation on that data within one or more given fields.

These and other drawbacks exist with current systems and methods for managing tasks. Accordingly, there exists a need for a system and method for managing tasks that is efficient, flexible, and robust that can address the aforementioned issues of task and project management systems.

### SUMMARY OF THE INVENTION

The present inventors have recognized a need for an efficient and reliable method for a plurality of persons to interact with a task-management activity, and as a result have provided a web-based task management system and method.

In one embodiment a computer-implemented method for generating an email update request from an initiating client to a recipient account is provided, comprising the steps of: (a) sending instructions to the initiating client operable for: (i) presenting a task sheet to the initiating client, the task sheet having at least one task and a set of associated cells; (ii) receiving an email update request command from the initiating client; (iii) presenting a user interface configured to enable selection of a subset of the associated cells; (b) receiving the selected subset of the associated cells; (c) generating the email update request based on the selected subset of the associated cells; and (d) transmitting the email update request for update to an email address associated with the recipient account.

In another aspect computer system configured to manage a task hierarchy is provided, comprising a task data store configured to store information about a plurality of tasks, the task information including a parent task and a task unique identifier, a task sheet data store configured to store information about a plurality of tasks, the task sheet information including a task sheet unique identifier, a task to task sheet data store configured to store a plurality of relationships between tasks and task sheets, said relationships including a task unique identifier and a task sheet unique identifier.

In another aspect a computer-implemented method for managing tasks is provided, comprising (a) receiving information for creating a first task sheet; (b) creating the first task sheet and assigning the first task sheet a unique identifier; (c) receiving information for creating a first task relating to the first task sheet; (d) creating the first task and assigning the task a unique identifier; (e) creating a relationship between the first task sheet and the first task; (f) receiving information for creating a second task sheet; (g) creating the second task sheet and assigning the second task sheet a unique identifier; and (h) creating a relationship between the second task sheet and the first task.

In yet another aspect a computer system for managing a plurality of task sheet templates is provided, comprising a task sheet data store configured to store information about the plurality of task sheets, a column definition data store configured to store schema information about a plurality of system defined column types and further configured to receive and store information relating to user defined column types, a row definition data store configured to store schema information about a plurality of system defined row types and further configured to receive and store information relating to user defined row types, and a task sheet data store configured to store relationships between task sheets and column and row definitions.

In still another aspect a computer system for coordinating information between a client and a server using a client side in-memory database is provided, comprising a server having a server processing unit, a server memory device, and a server data storage device; a server program stored in the server data storage device for providing instructions to the server processing unit; a server database in the server data storage device for managing relational data; and the server processing unit responsive to the instructions of the server program, operable for: transmitting database structure instructions to the client; transmitting initial data to the client; and receiving data updates from the client; wherein the client comprises client processing unit; a client memory device; a client data storage device; a web browser program stored in the client data storage device for providing instructions to the client processing unit; and wherein the client processing unit is responsive to the instructions of the web browser program for creating the client side in-memory database operating within the context of the web process based on the transmitted database structure instructions, the client side in-memory database configured to manage relational data; populating the client side in-memory database based on the transmitted initial data; generating a user interface configured to receive user input; updating data in the client side in-memory database based on input received by the user interface; and transmitting updated data to the server database.

In yet another aspect a computer-implemented method for coordinating information between a client and a server using a client side in-memory database s provided, comprising transmitting database structure instructions from the server to the client; transmitting initial data from the server to the client; creating a client side in-memory database operating within the context of the web process based on the transmitted database structure instructions, the in-memory database configured to manage relational data; populating the client side in-memory database based on the transmitted initial data; generating, by the web browser, a user interface configured to receive user input; updating data in the client side in-memory database based on input received by the user interface; transmitting updated data from the client side in-memory database to the server database; and selectively updating the data in the server database based on received updated data.

### BRIEF DESCRIPTION OF THE DRAWING FIGURES

FIG. 1 is FIG. 1 is a block diagram illustrating an exemplary embodiment of a server system in accordance with the present invention;

FIG. 2 is a high-level flow diagram illustrating a user logging in, being authorized and user interaction in an embodiment of the invention;

FIG. 3 is an object diagram of multi-user database access in an embodiment;

FIG. 4 is an object diagram of two separate views of data within the local database in an embodiment;

FIG. 5A is a high-level flowchart diagram of the update request feature in an embodiment;

FIG. 5B is a high-level flowchart diagram of the update request feature in an embodiment;

FIG. 6 is a flowchart diagram of a user receiving update an request in email in an embodiment;

FIG. 7 is a flowchart describing an update request process in an embodiment;

FIG. 8 is a wire frame image of a task sheet in an embodiment;

FIG. 9 is a detailed flowchart of generating an email update request method in an embodiment;

FIG. 10 is a logical representation of a task hierarchy data store in an embodiment;

FIG. 11 is a task management method that depicts creation and association of tasks and task sheets in an embodiment;

FIG. 12 is a logical representation of a task sheet template system in an embodiment;

FIG. 13 is a logical representation of a Client Side In-Memory Database in an embodiment;

FIG. 14 is a flowchart of a Client Side In-Memory Database Method in an embodiment;

FIG. 15 illustrated highlighted cells based on change history in an embodiment;

FIG. 16 illustrates a users ability to select time range and color for change history highlighting in an embodiment;

FIG. 17 illustrates the menu selection to show history report for a given field in an embodiment; and.

FIG. 18 illustrates the dynamic history report for a given field in an embodiment.

For purposes of clarity and brevity, like elements and components will bear the same designations and numbering throughout the Figures.

### DETAILED DESCRIPTION

Embodiments of this invention provide a column and row web-based interface to describe tasks, sub-tasks and associated values for these tasks. For the purpose of this description, this interface is referred to as a “task sheet”. A task sheet in embodiments of the invention functions as a primary user interface within a task management system. Exemplary embodiments enable a user to edit and share data securely and efficiently within one or more of task sheets. A user also has the ability to request and authorize collaboration with other users.

For purposes of this description, the term “task management system” refers to an application that provides an environment wherein a plurality of users can access, edit and otherwise manipulate data related to tasks within a project. Exemplary embodiments provided in this description refer to a web-based application wherein client side software is loaded within the context of a web browser when a particular web page is accessed. The client side, web-based software interacts with server side software and a database stored on a web server. The broad aspects and features of the invention, however, are not limited to a web-based application.

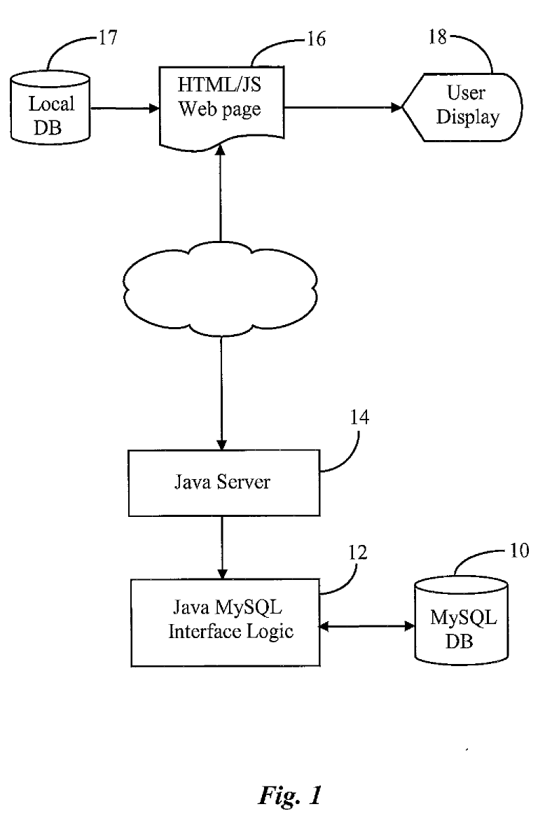

FIG. 1 is a diagram illustrating various components within the task management system in an embodiment of the invention. Database (DB) 10 is stored on a server wherein the application can access the data and contents as needed. The database functions are abstracted 12 by a customized application library. The reasons for abstraction are to provide portability in applications, optimization to standard database operations and other processing enhancements related to a custom application. Abstraction layers are common in web-based applications and known to those knowledgeable in the field. The DB abstraction library is a component of the web server 14. In this embodiment the web server is implemented in Java™. Java is one of many environments that can support web-based applications available on the market today.

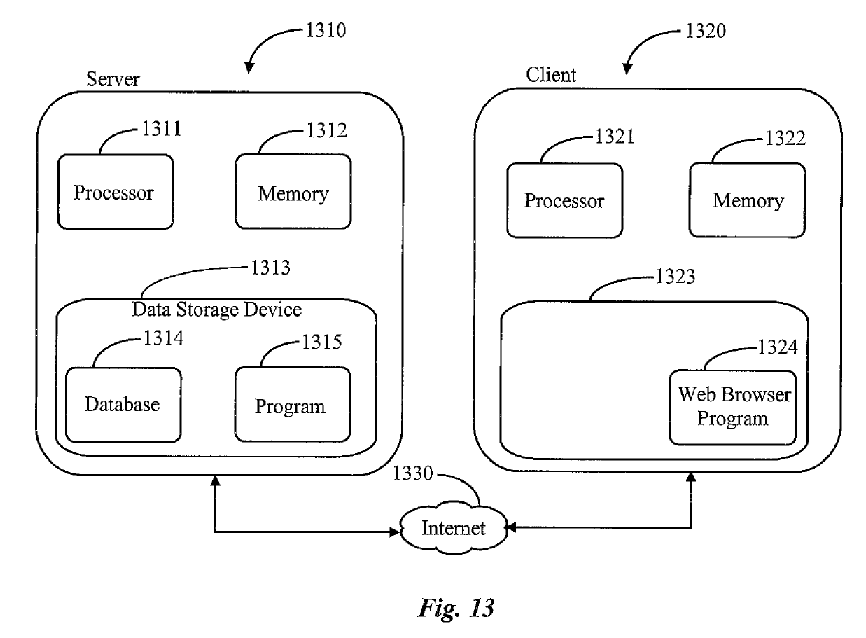

A user of this system accesses the web site stored on the web server 14 via a standard web browser 16. When the client accesses the task management system a local database 17 (explained in greater detail with respect to FIG. 13) is loaded into cache memory on the client machine. This local database contains user information, user interface data and other relevant information pertaining to the user's project management environment. In addition local database 17 performs function of storing changes performed by the user while using this system. The local database is implemented in JavaScript in one embodiment. JavaScript is a common web scripting language, which allows programmers to create interactive web applications.

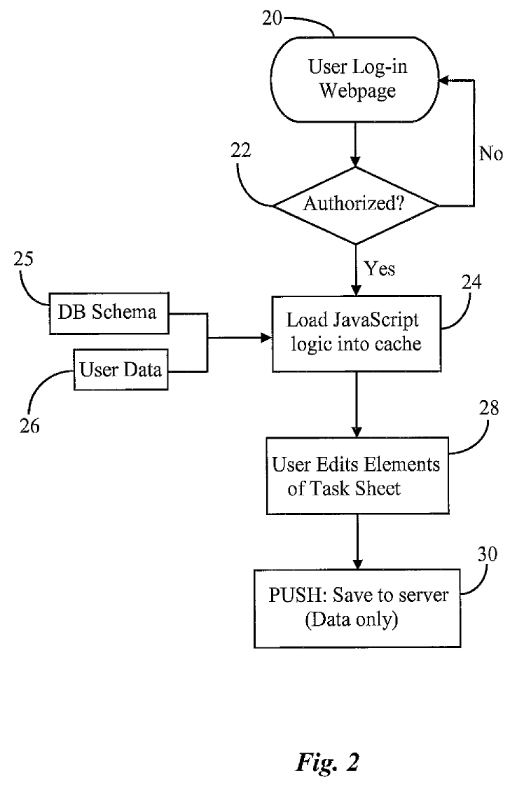

FIG. 2 is an exemplary flow diagram illustrating a process of a user accessing the project management system and interacting with a task sheet. The system presents the user with a log-in web page at step 20. The user enters a username and password, then authentication and authorization is accomplished at step 22. If the user is not authenticated the user is notified that the entered credentials are not valid, and the user is returned to the log-in webpage to make another log-in attempt. The user may select a particular task sheet by first logging in, and then selecting a task sheet from a web page, by including a task sheet identifier in a URL, a default task sheet may be loaded, and other mechanisms may be used to identify a selected task sheet. The task sheets associated with a user, the task sheet interface attributes and the task sheet contents are based on data stored in the DB 10 (FIG. 1).

Once the user is authenticated and authorized to view a selected task sheet the web server transmits at step 24 database schema 25 and user information 26 corresponding to the selected task sheet to be loaded by the web browser. In a preferred embodiment Dynamic HyperText Markup Language (DHTML) is used, which is a combination of HTML and JavaScript. This is the implementation methodology used to display the task sheets and control the overall project management web site in exemplary embodiments.

The user performs operations on a task sheet at step 28. When these operations result in changes of data values within the task sheet, the changes are stored in the client-side, in-memory database, as described in greater detail with respect to FIG. 13 below. Storing this information in a local database as opposed to a non-local, or remote, database provides the application a faster response time to user requests and makes the application less susceptible to network connectivity problems. For example, if there is a temporary network connectivity problem, a user may continue to work with the task sheet while data changes are stored in the local database, and these changes can be synchronized with the non-local database 10 when connectivity is restored. Task sheet data may be saved to the server when instructed by the user, upon the occurrence of a predetermined event, or based on other criteria.

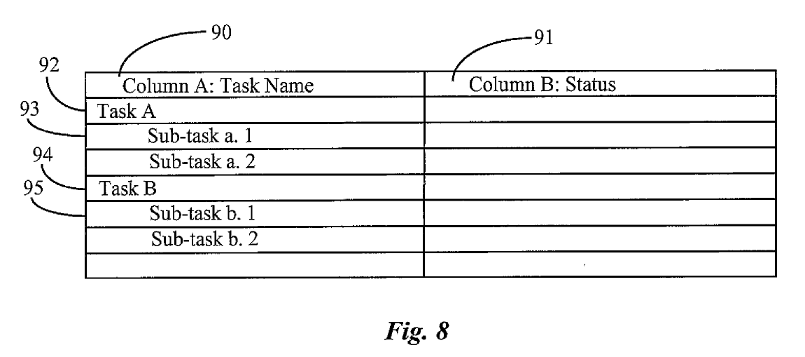

If, for example, a user performs an action which causes a fundamental change in task sheet layout (FIG. 8), such as adding or deleting a column 90 or multiple-row deletion 92, 93, then this information may be updated both locally and on server 30 immediately. To conserve the amount of data transmitted between the client and server, the client-side database may transmit only data that has changed to the server to be updated. In a preferred embodiment, Extensible Markup Language (XML) is used as the communication format between client and server. In a preferred embodiment communication between the server and client uses a simple text based format to reduce parsing and processing time on the client. Another embodiment allows for the text based format to be encrypted and obfuscated using either standard or proprietary mechanisms. Furthermore, in a preferred embodiment the system uses Secure Socket Layer (SSL) to encrypt transmissions between client and server. SSL is a common security medium for web-based applications, and known to those familiar in the art.

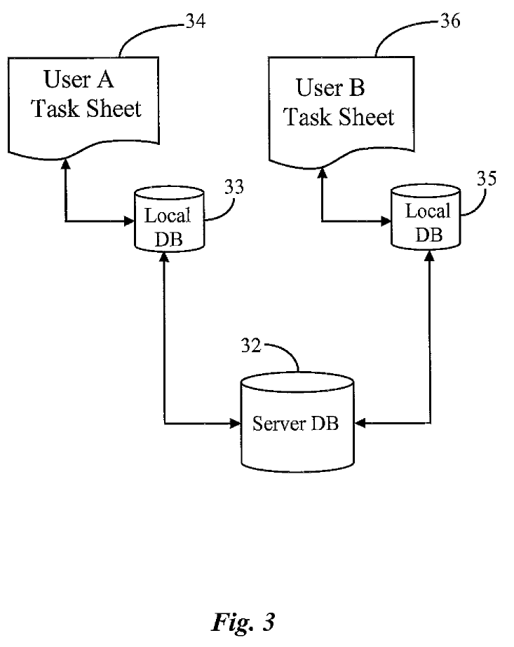

FIG. 3 is an exemplary diagram illustrating sharing abilities of a task sheet between two users. A task sheet 34 created by User A may be configured to be private or shared. In private mode only the authorized user can view, edit and otherwise manipulate the task sheet. In shared mode a task sheet administrator can share the task sheet with one or more individuals. In this example User B 36 has access to the same task sheet as User A 34, that is, the task sheet labeled User A Task Sheet, and the task sheet labeled User B Task Sheet, are the same task sheet. As described above, users can each make changes to the same task sheet. The change information is stored in local database 33 and 35 respectively, depending on which user makes the changes, until such time as saved by the user, at which time it is stored on server database 32. The server processes requests to save data from one or more users to save data in the order received. The changed data is updated on the server, then sent to other users currently logged in with access to the same task sheet. As explained in greater detail below, local database 33 and 35 are databases managed within the context of a web browser, preferably using a client side scripting language such as JavaScript.

For purposes of illustration only two users are shown in FIG. 3, this in no way implies limitation on the number of users that can access a task sheet or the task management system concurrently.

The user that creates an initial task sheet can select the permission levels for other users as it relates to a given task sheet. These permissions allow authorized users read/write, full access, or read-only ability on a given task sheet.

The system allows shared-row mode, by allowing the sharing of one or more rows within a task sheet. In this mode, only the authorized rows are shared to the authorized users. Full access, read/write and read-only permissions may be implemented in the shared-row mode, and other types of permissions may also be used based on the needs of the system.

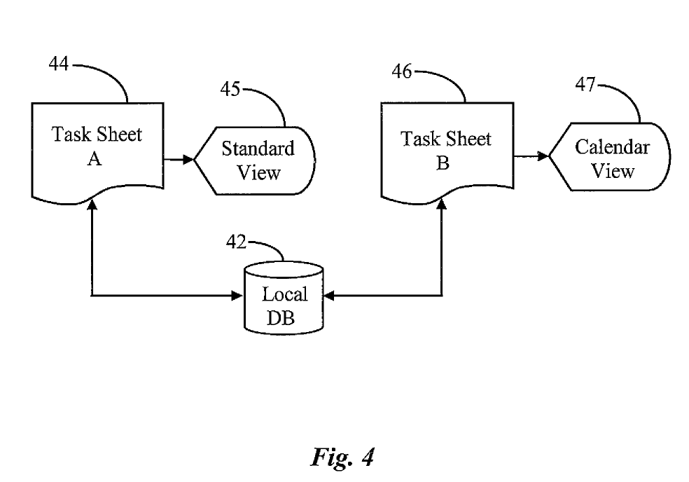

FIG. 4. Is an exemplary diagram illustrating the system's ability to display one or more simultaneous task sheets to a user with two different types of representations. Task sheet A 44 displays data in a standard column and row view 45 while task sheet B 46 displays data in a calendar view 47. In one embodiment, the tasks associated with task sheets 44 and 46 may be the same, such that the difference between the task sheets is the manner of presentation of data. By way of specific example, a task date may be represented as Jan. 1, 2007. The data stored in the local database represents this value. When a user loads task sheet B 46 a graphical calendar appears on the task sheet highlighting the date Jan. 1, 2007.

In a preferred embodiment, graphical modification to a non-active task sheet based on changes made to an active task sheet preferably occurs without communication with the server. For example, if a user changes the date value of a task in task sheet A 44, the location of this task may be changed in task sheet B 46 without transmitting information to the server. In this example, and throughout this description, a task sheet is a user interface running within a web browser. In a preferred embodiment, the task sheet is generated using DHTML and does not rely on Active-X components or other installed components/modules.

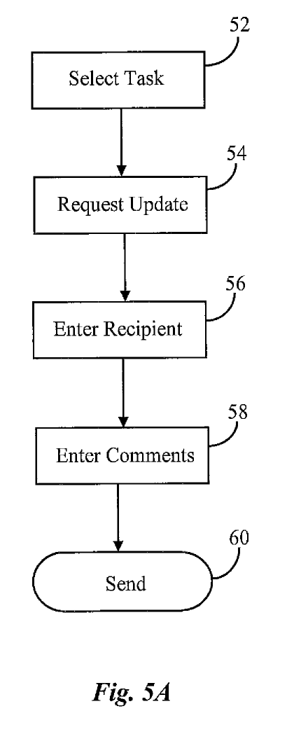

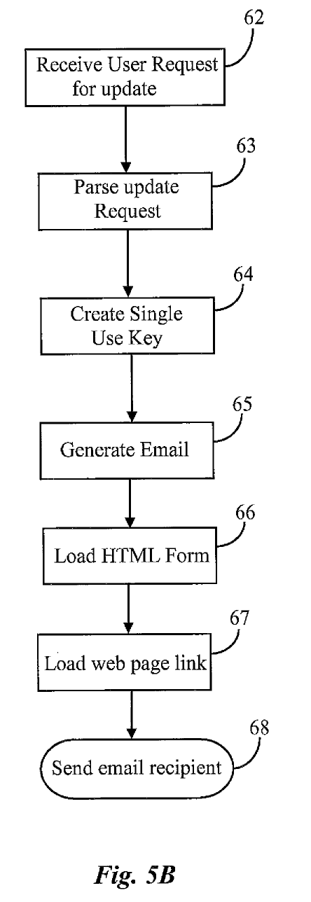

FIGS. 5A and 5B are flow diagrams illustrating how a user can request task updates from another user, and how the request to provide an update from a user is processed by the web server. Referring to FIG. 5A, the user selects the task they want to have updated in step 52, right-clicks with a pointer device to display a menu, and selects ‘Request Update’ at step 54 from the menu. A pop-up window is displayed allowing the user to enter recipient information at step 56, comments, or other relevant information to the update request, are entered at step 58. In a preferred embodiment, the user may also select a subset of information to send to the user, as described in greater detail below. The user then submits the request to the server at step 60, for processing.

Referring now to FIG. 5B, an update request is received at step 62 by a process executing on the server. The process parses the users request information at step 63. The process then creates a single-use authorization key at step 64 to be associated with the update request. The authorization key may be used to make a single update relating to an associated task (e.g., the authorization key is a single-use key that may be used to update an associated task without authentication). For example, if a request to update a first task is initiated, an authorization key will be generated and associated with the first task. If this authorization key is presented by an unauthenticated user, the process will instruct the server to allow the recipient to enter information directly to the database as it relates to the first task. An attempt to use the authorization key to update a second task will fail. Additionally, an attempt to use the authorization key to update the first task a second time will fail.

The server then generates at step 65 an email to the recipient inserting both an HTML form at step 66 and a link to a web page at step 67. The server inserts both the HTML form and a web page URL. This provides users that cannot display HTML forms from within their email client the ability to use the URL to access the server and provide the requested update information. Once the email has been generated and populated with the information provided by the requestor, the email is sent at step 68 to the recipient.

The HTML form embedded in the e-mail provides a simple interface whereby the user can update progress, task due date and provide general comments about a task. Although the examples are described primarily with one update request and one recipient, one skilled in the art will recognize that an update request is not limited to one task, or to only one recipient.

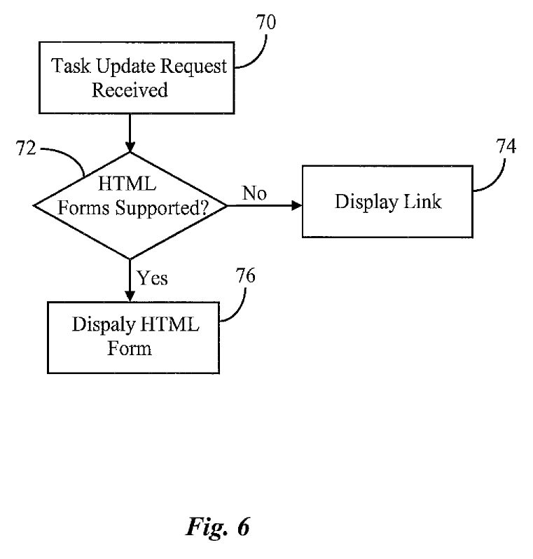

FIG. 6 is an exemplary flow diagram illustrating steps in a process with a recipient's email application when an update request email is received. The task update request is received as email at step 70 by a user's application. The application then determines if HTML forms are supported at step 72. If they are not, then the application displays the URL at step 74 to access a webpage where the user can provide the task update information. If HTML forms can be displayed, then the form is rendered directly in the recipients email application at step 76.

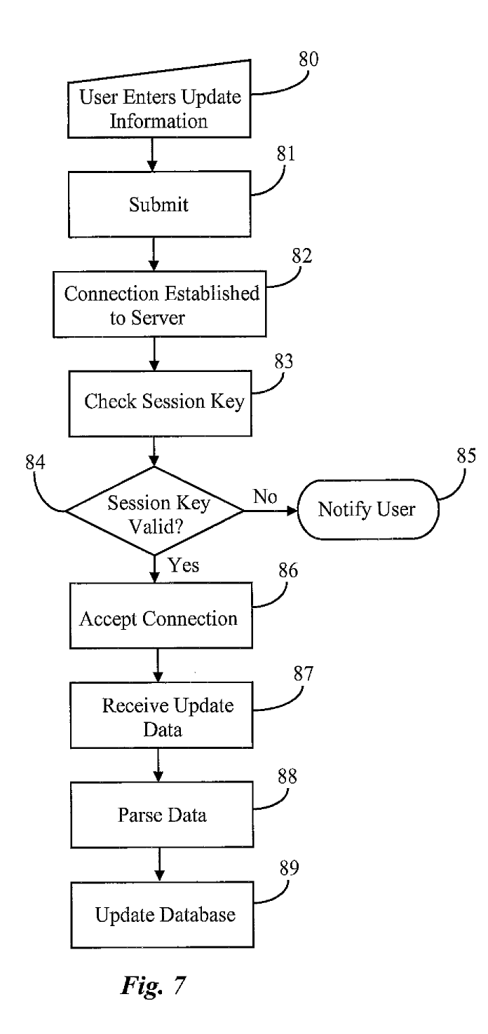

FIG. 7 is an exemplary flow diagram of a process by which the server receives the task update information back from the recipient. The HTML form allows the recipient to provide all requested task information at step 80 directly within the body of the email. Once task information is provided the user submits at step 81 the update directly to the server from the email form. In the case where the recipient uses the email form, upon submission by the recipient, the form creates a process to establish a connection at step 82 to the server (e.g., posts the form data to the server in a conventional HTTP message). Once the information is posted to the server, the single-use authorization key is checked for validity at step 83. If the key is not valid, then the user is notified at step 85. If the key is valid at step 84, then connection is accepted at step 86. A process executing on the server receives the update information at step 87 and parses the information at step 88 accordingly. Once the information has been parsed, the process then updates the database at step 89, as it relates to the given task for the given task sheet. In a case where the recipient uses the URL, the authorization key allows the recipient to view a secure web page. This web page allows the recipient to enter all relevant task update information and submit.

Once update information is received by the server, the access key then expires. Future attempts (if any) by the recipient to enter information in the HTML email form or attempts to log in to the task sheet system will be denied at step 84, and the user will be notified at step 85 that they have already performed this task.

### EXEMPLARY EMBODIMENTS

### Update Request

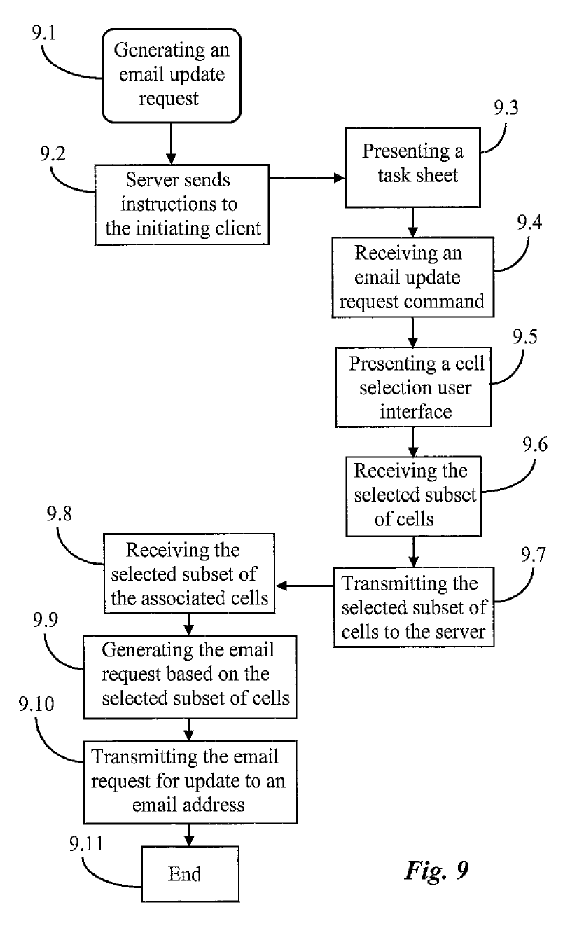

FIG. 9 depicts a flow chart of a computer-implemented method for generating an email update request from an initiating client to a recipient account at step 9.1. Elements to the left are steps implemented on a server, while elements to the right are steps implemented on a client. Specifically, the server sends instructions to the initiating client at step 9.2 (e.g., in response to a client requesting a web page). These instructions may be in the form of a DHTML web page having JavaScript functions that, when rendered in a suitable web browser (e.g., FireFox 2 or Internet Explorer 7), cause the specified functionality to be performed within the context of the web browser. The web pages may be generated based on data stored in a database, applications running on a web server, files stored in a file system, a combination thereof, and other criteria.

In a preferred embodiment the instructions may be referred to as a client-side in-memory application, or client application. The client application may be operable for presenting a task sheet to the initiating client at step 9.3, the task sheet having at least one task and a set of associated cells (e.g., the task sheet depicted in FIG. 8). When the task sheet is rendered, it may include control elements that enable a user to perform predetermined functionality (e.g., submit buttons, images, div tags or other layout elements having associated client-side JavaScript functionality, etc.). In a preferred embodiment, when a user right-clicks within a particular task (e.g., right-clicks within a row on a task sheet, for example), one of the options may be to “Request Email Update”.

When “Request Email Update” is selected by a user, the client application may receive the email update request command from the initiating client at step 9.4 (e.g., at the web browser interface), and present at step 9.5 a new user interface configured to enable selection of a subset of the associated cells.

In a preferred embodiment, the request email update user interface enables a user to enter comments that will accompany the generated email that will be sent to a designated recipient. Additionally, this interface may enable the user to select which cells or fields to include in the generated email. For example, a task may have six different columns (e.g., Name and Status, as shown in FIG. 8, as well as Due Date, Budget Available, and Budget Used, and Percentage Complete, which are not shown). A user may want to focus the recipient's attention on a subset of information (e.g., Name, Status, and Percentage Complete), and leave the other information off the email (e.g., the budget information). Radio buttons, check boxes, or other controls may be used to enable a user to select which information will be included in the generated email. In a preferred embodiment a user may select a “Fields” control that, when selected, presents the user with two columns of information: available columns and current selections. The user may move fields between columns by, for example, selecting a field and selecting a left or right arrow key to move the field to the other column. Fields in the current selections column may be included in the generated email. The client application may receive the selected subset of fields (corresponding to cells on the task sheet) at step 9.6.

Once a user has selected a subset of fields (and provided comments, if any), the information may be transmitted to the server at step 9.7 and received by the server at step 9.8. The server may then generate the email request based on the selected subset of the associated cells at step 9.9. Extending the example provided above, the generated email would, in this example, include the Name, Status, and Percentage Complete fields (e.g., the field name and the value of the cell on the task sheet), while the budget available and budget used fields would not be included. The generated email may then be transmitted to an intended recipient at step 9.10. Although the process of generating and transmitting the email may be conducted by the same machine as the web server(s), it is likely that in many embodiments a separate machine (or machines) will be used to handle the email functionality and such machines will work in a coordinated manner to perform the described functionality of the server.

### Task Hierarchy Data Store

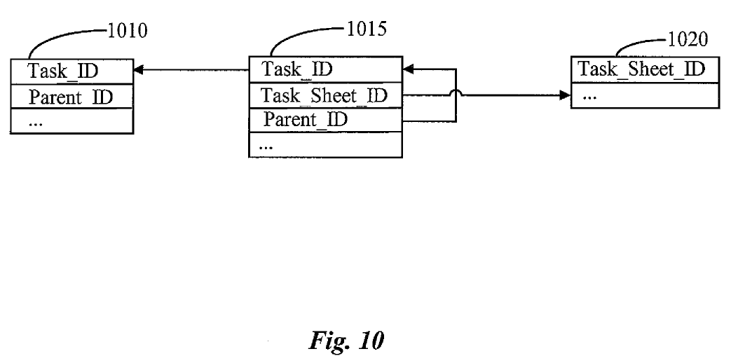

FIG. 10 depicts a task hierarchy data store that enables flexible representation and management of various tasks on task groupings referred to as task sheets. In a preferred embodiment the computer system includes a task data store 1010 configured to store information about a plurality of tasks, the task information including a task unique identifier. The parent task is relevant to the task sheet in which it is present. Any cross-referencing of tasks between sheets, associates the parent reference. In addition, these tasks can have multiple parent tasks, as defined by the individual task sheet on which they are located. The task sheet information is stored in a task sheet data store 1020 configured to store information about a plurality of tasks, the task sheet information including a task sheet unique identifier.

There is a task-to-task sheet data store 1015 (e.g., a junction table) that associates records (or entries) in the task data store 1010 to the task sheet data store 1020 in a many-to-many manner. Each record in the task-to-task sheet data store 1015 includes data identifying a task unique identifier and a task sheet unique identifier. In this way, a single task may be associated with one or more task sheets and a single task sheet may have one or more associated tasks. Additionally, the task-to-task sheet data store 1015 may store data that identifies a parent/child relationship between tasks for a given task sheet. Accordingly, a parent/child relationship may exist between two tasks on a first task sheet, while no parent/child relationship exists between these two tasks on a second task sheet.

In one embodiment permissions may be applied at the task level, at the task sheet level, a combination thereof, and using different authorization schemes. In a preferred embodiment, permissions associated to that task are applied to every sheet that task is shared on. For example if a task is designated as Read-Only, any sheet that task is shared to will only be able to access that task as Read-Only. Although FIG. 10 and the corresponding description indicates a relational database system (e.g., MySQL, Oracle, SQL Server, etc.) other types of data stores could be used (e.g., XML) without departing from the scope of the present invention.

### Task Management Method

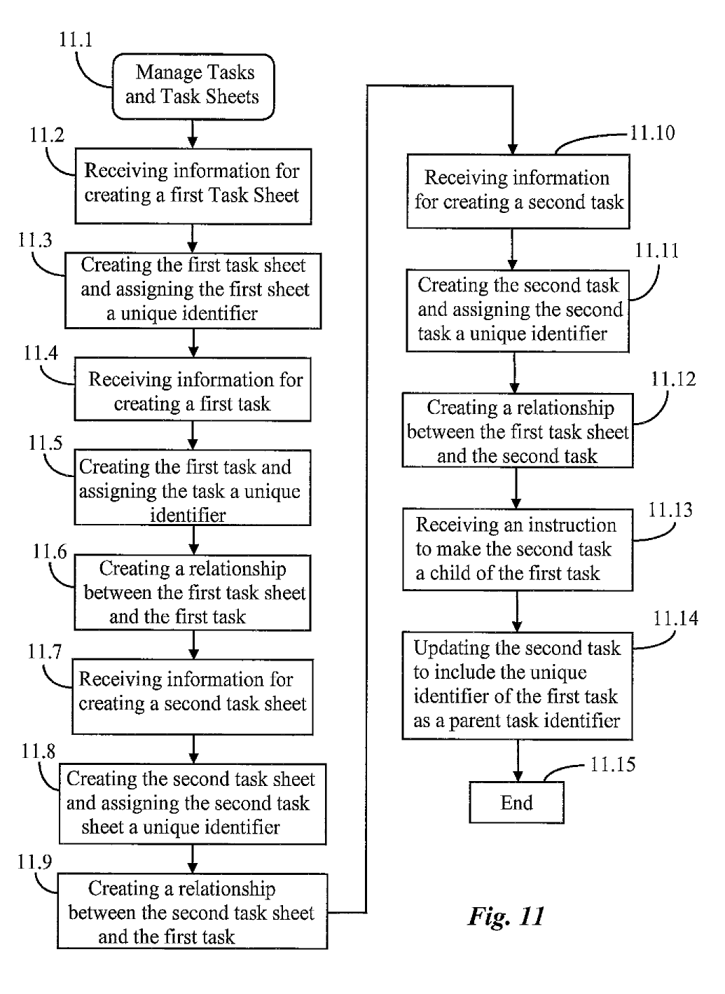

FIG. 11 depicts a method of managing tasks in an embodiment of the present invention. This method is described from the perspective of a server system (e.g., a single machine performing the described functionality or a combination of machines, software, and networking resources operating in coordination to provide the described functionality). At the conclusion of this section there is a brief overview of the behavior of the client system (which is where the task management information is initially collected by the task management system).

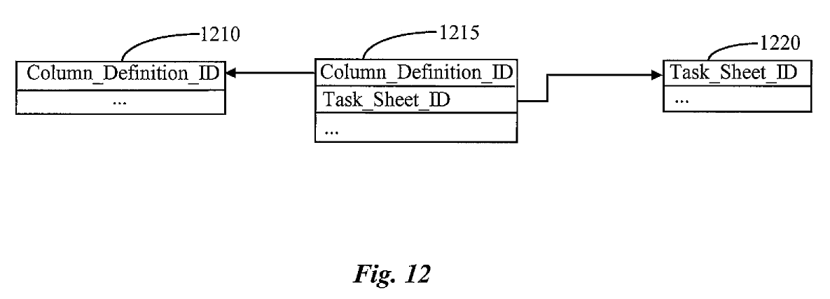

The method begins at step 11.1. The server receives information for creating a first task sheet at step 11.2, such as a task sheet name. In a preferred embodiment, and as described in greater detail below with respect to FIG. 12, a task sheet template may also be used. The server then creates the task sheet and assigns the task sheet a unique identifier at step 11.3. The server then receives information for creating a first task relating to the created task sheet at step 11.4, such as a task name and a task status. A task is created based on the received information, and a unique identifier is assigned to the task at step 11.5. A relationship between the task and the task sheet is then created at step 11.6, as described above with respect to FIG. 10.

The server receives information for creating a second task sheet at step 11.7. The server then creates the second task sheet and assigns a second unique identifier at step 11.8. The first task is then associated with the second task sheet at step 11.9. In a preferred embodiment, and as depicted in step 11.9, a single task may be associated with multiple task sheets.

The process of creating a second task is similar. The server receives information for creating a second task relating to the created task sheet at step 11.10. A second task is created based on the received information, and a unique identifier (different than the unique identifier assigned to the first task) is assigned to the second task at step 11.11. A relationship between the second task and the first task sheet is then created at step 11.12. In addition to the differences caused by different information received (e.g., different task names), the tasks will have different unique identifiers, and these unique identifiers will be used to establish relationships between tasks and task sheets in the task to task sheet data store.

In addition to relating tasks and task sheets, tasks may be related to each other in a parent/child (task/sub-task) relationship, which may be implemented as a self-referential relationship (as depicted in FIG. 10). For example, an instruction may be received to make the second task a child task of the first task at step 11.13 (e.g., a user selects the second task and then clicks on an “Indent” command). In response to this instruction the second task may be made a child of the first task by updating the parent ID column of the second task to the unique identifier of the first column at step 11.14.

In addition to the server side functionality described above, client-side functionality may be utilized that enables task sheets and tasks to be managed without communication with the server system. This functionality may be implemented by assigning client-side unique identifiers to items created on the client. These client-side unique identifiers may have a pattern that is different than server side unique identifiers (e.g., client side unique identifiers may always be negative, while server side unique identifiers may always be positive, for example). When synchronizations between the server and the client take place, the server may detect the presence of client-side unique identifiers, and perform insert commands to create the new records/relationships. The new server-side unique identifiers may then be transmitted to the client, such that eventually the client-side unique identifiers are eventually refreshed with the permanent server-side counterpart.

The above description relates to a Task Management method from the server perspective. In a preferred embodiment, the Task Management method may be implemented using a client side in-memory database, the technical aspects of which are described in greater detail below. When a task management system is used that involves a web server and a client side in-memory database, the following particular methodology may be implemented:

Creating a Task Sheet (All on client-side database (DB) only)
User selects to create a new task sheet
In local DB create a new Task_Sheet record. Task_Sheet_ID is negative. (local DB IDs start at (−1) and decrease)

In local DB create Task records (50 by default). Task_ID's are negative (local DB IDs start at (−1) and decrease)

In local DB create Task_Junction records (FIG. 10-1015) (50 by default).
Task_ID of each new task (negative ID's)
Task_Sheet_ID of new Task_Sheet (negative ID)
Parent_ID is null. Initial hierarchy has each task as peer to one another.
In local DB create Column_Junction records (FIG. 12-1215) (one record for each column).
Column_Definition_ID of each column (positive ID)
Task_Sheet_ID of new Task_Sheet (negative ID)
Adding a Task to the new Smart Sheet (All on client-side DB only)

In the local DB create a Task record. TASK ID will be negative In the local DB create a Task_Junction record

Task_ID of new task (negative ID)
Task_Sheet_ID of new Task_Sheet (negative ID)
Parent_ID is null. Initial hierarchy has each task as peer to one another.
If task is indented (make sub task) this changes the Parent_ID on the Task_Junction record from null to the Task_ID of the parent Task.

### Saving to Server

Package into 1 request using XML. Only changed data is transmitted.
All changed records from related tables are sent to the server in a single request
Tables included in saving a Sheet: Task_Sheet, Task, Task_Junction, Column/Junction
Response to client
Server assigns permanent ID's (Task Sheet_ID, Task_ID, etc . . . )
Any changed data since previous save (i.e.: changes by other users)
Package in proprietary format
Send to client

Task Sheet Templates

FIG. 12 depicts a logical representation of a computer system, and in particular a data store (e.g., a plurality of database tables) that may be used to build new task sheets from templates and to create new task sheet templates. A task sheet data store 1220 is configured to store information about the plurality of task sheets. For example, this data store may include the task sheet unique identifiers, task sheet names, and other information about the task sheet. This task sheet data store may be the task sheet data store 1020 depicted in FIG. 10 (thereby enabling the systems described with respect to FIGS. 10 and 12 to be used in conjunction with one another).

A column definition data store 1210 is configured to store schema information about a plurality of system-defined column types. System defined column types may be provided by a service provider, and have general applicability for a user base (e.g., % complete, approver, budget, comments, company, etc.). Additionally, if a user has requirement for a column type not provided, the user may add it using a web browser. For example, if a company refers to an “approver” as a “supervisor”, the user may change the column definition of an “approver” column so that it is labeled as “supervisor.” Additionally, a user may create a new column definition, assign this column definition a label (or name), and select a column type, such as free text (which will cause a text box to be rendered on a task sheet), pick list (in which the user can further specify available options for the pick list, and these options will be available in a drop-down list created when a task sheet is displayed), date (which will cause a date validation to be applied to a cell and enable a calendar look-up functionality on the task sheet when displayed), user lookup (which will cause a drop-down list with user information to be created when the task sheet is displayed), and number (including decimal places and ranges). Other settings and types may be used.

Which column definitions appear on a particular task sheet is determined a task sheet to column definition data store 1215, which serves as a junction table enabling a many-to-many relationship to exist between column definition data store 1210 and task sheet data store 1220. In addition to associating columns with a template, a preferred embodiment of the present invention enables users to associate rows with a template as well. A row may, for example, correspond to a task. Accordingly, when a user generates a new task sheet based on a template, the system may associate both columns and rows with the task sheet. For example, when a user creates a new task sheet based on a “New Hire Checklist” template, the task sheet may be created with a number of columns (e.g., Task Name, Status, Due Date, Comments, etc.), and a number of rows or tasks already present (e.g., Assemble Personnel File, Collect Direct Deposit Form, Collect 1-9, etc.). The tasks may have only a task name default value (e.g., status, due date, comments, and other fields are blank) or have additional values pre-populated (e.g., provide a due date of the present date plus one week as a default value for collecting direct deposit forms, provide a comment that describes a task in greater detail, etc.).

In a preferred embodiment the system provides a user interface to an online data store, wherein a user can view, search, compare, download and upload task sheet templates. The interface provides an ability for a user to view all templates within the data store or allows the user to navigate through one or more labeled categories for a given type for task sheet template. Within the template data store interface, a user can select and download to their local task sheet environment any of the task sheets that are provided in the online data store. The user interface also provides the user with an ability to preview the task sheet template, prior to downloading.

In a preferred embodiment the data store interface allows a user to upload templates for others to use. When uploading a template the user provides additional information about the task sheet template they are uploading, such as ‘Created by’, ‘General Purpose’, ‘Detailed Description’, and the like.

In addition to the individual template, description data may also accompany the task sheet template. For example some of the data that may accompany the template identifies the creator, date uploaded, last updated date, market or project sector task sheet relates to, reviews from other users of the task sheet, and ratings of the task sheet based on the ranking provided by other users based on their experience with a given template. The description data can be viewed within the data store interface, on one or more selected task sheet templates.

In a preferred embodiment, when a template category has more than one task sheet that directly relates to management of a given task type, for example project management, the system provides a compare utility, wherein the utility displays the principle differences between the task sheets such as number of fields, columns types, type or project relating to, etc. In addition the compare utility can also display data from other users as described above as it relates to the task sheets.

### Client Side In-Memory Database

Although the task management system described above provides benefits to a user, including rich collaborative functionality without the need to install a local application, providing such functionality within a web browser presents a number of programming challenges. First, because much of the functionality occurs on the client without communication with the server, it is necessary to manipulate data on the client in a manner similar to the way data is managed on the server. Accordingly, it is advantageous to have a client-side “abstracted data store” capable of managing data in a manner similar to the way data is managed on the server. Second, this client-side database should provide seamless integration into the server-side database. One way of facilitating seamless integration is to ensure that the client-side and server-side databases are laid out exactly the same (e.g., have the same schema). Third, the client side in-memory database may be bound to a user interface, such that when the data changes the user interface is updated accordingly. Fourth, the client side in-memory database enables querying in a manner similar to conventional server side queries, but these queries are conducted by a web browser without communication with a web server (e.g., the web page may query the client side in-memory database to ask “what tasks are associated with this task sheet). The client side in-memory database may also provide data modification awareness, such that only the latest changes are saved back to the server. This feature is important because it enables advanced functionality, including the highlighting of changed data elements described below.

Additional functionality enabled by the client side in-memory database include foreign key management (e.g., managing relationships between task sheets and tasks), and grid management. Furthermore, the client side in-memory database may manage permissions on the client side to prevent users from making data modifications for which they are not authorized.

Turning from the functionality of the client side in-memory database to an exemplary implementation, FIG. 13 represents a client side in-memory database that enables installed application-like performance in a web-based application. Server 1310 includes a processor 1311, a memory device 1312 (e.g., RAM), and a data storage device 1313 (e.g., a disk drive). The data storage device 1313 may include a database program 1314 and a task management program 1315. The database may be a conventional RDMS database. The task management program 1315 may be configured to transmit database-structure instructions to the client, transmit initial data to the client, and receiving data updates from the client. The database-structure instructions may be instructions to create in-memory tables, relationships between these tables, and constraints upon these tables.

Client 1320 includes a processor 1321, a memory device 1322, and a data storage device 1323. The data storage device includes a web browser program 1324 (e.g., FireFox, Internet Explorer, etc.). A database program is not depicted in the client data storage device 1323 because the present invention does not rely on a client-side, installed database program, but instead creates an in-memory client side database as described in greater detail below. It is understood that a client may have a database program installed without departing from the scope of the present invention.

The web browser program 1324 stored in the client data storage device provides predetermined instructions to the client processing unit (e.g., the manner in which HTML is rendered, the manner in which JavaScript functions are evaluated, the manner in which third party components are activated, etc.). In a preferred embodiment, the web browser receives instructions from the server 1310 via a network connection (e.g., the Internet 1330). These instructions may be in the form of a DHTML web page, which includes JavaScript functionality that, when rendered on a client web browser, causes the specified functionality to be implemented. These instructions create a client-side in-memory database operating within the context of the web process based on the transmitted database structure instructions, the client-side in-memory database configured to manage relational data. Additionally, these received instructions cause the populating of the client-side in-memory database based on transmitted initial data. In addition to receiving instructions for creating the in-memory database, the web browser program receives instructions for generating a user interface configured to receive user input, updating data in the client side in-memory database based on input received by the user interface, and transmitting updated data to the server database.

### Client Side In-Memory Database Method

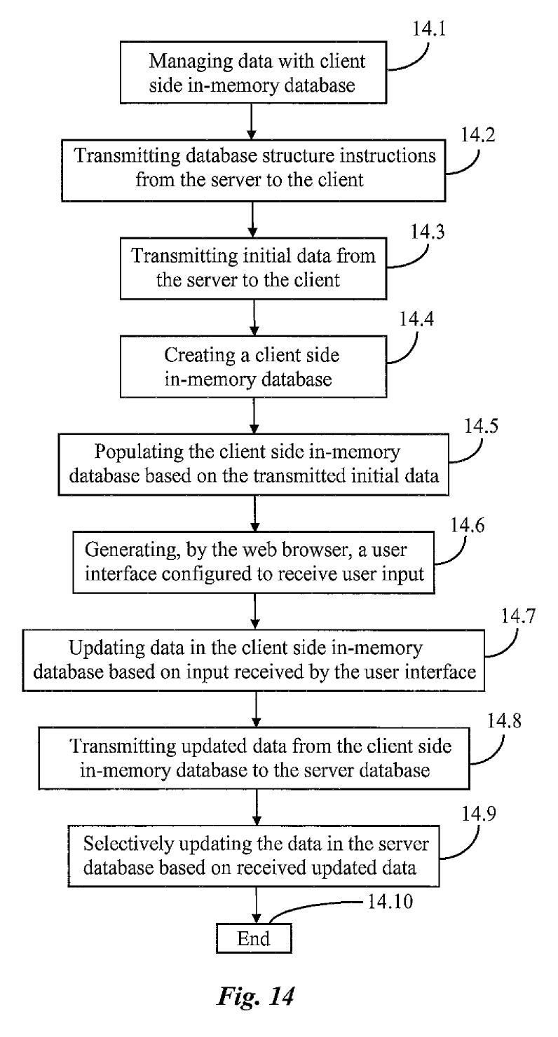

FIG. 14 represents a high-level overview of data management that involves a client side in-memory database. The process starts at step 14.1. The server transmits database structure instructions to the client at step 14.2 (e.g., the database structure depicted in FIGS. 10 and 12). A client side in-memory database operating within the context of the web process based on the transmitted database structure instructions is created at step 14.4. The server then transmits the initial data to the client at step 14.3 (e.g., the values populate the tables which have been created in-memory, such as the names of the tasks and task sheets and the relationships between tasks and task sheets). The in-memory database is configured to manage relational data.

Once the database structure is created, it is then populated with data based on the transmitted initial data in step 14.5. A web browser then generates a user interface configured to receive user input at step 14.6, such as a task sheet as described above. When a user interacts with the user interface (e.g., changing the value of a cell, adding a column to the task sheet, etc), data in the client side in-memory database is updated.

Data in the client side in-memory database and the server side database may be synchronized using a variety of methods. In one embodiment, data may be transmitted from the client to the server 14.8 periodically, upon a predetermined event or set of events (e.g., a user selects “Save” or selects a function that forces a server side save to be initiated), or based on other criteria. When the server receives the data, it may perform validation and authentication/authorization checks prior to updating the database and, if the checks are passed, commit the updates. In a preferred embodiment, the client side in-memory database may also receive updates from the server, such that if two users are working on the same task sheet, the users may be able to see modifications made by the other user.

### Change and History Identification

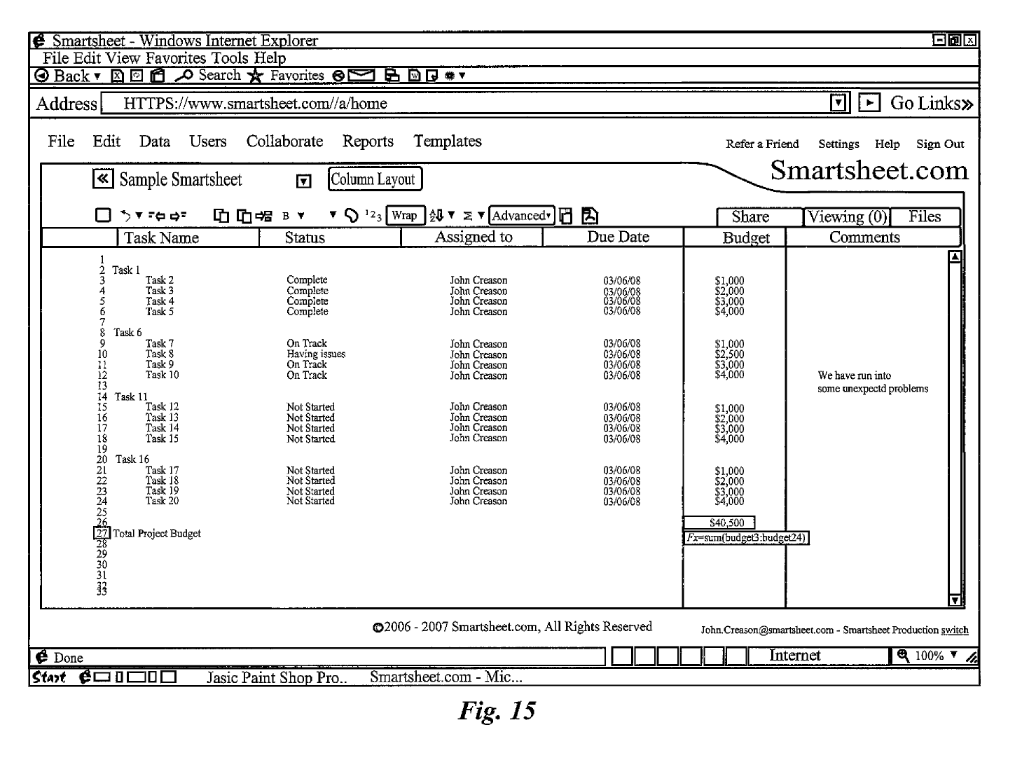

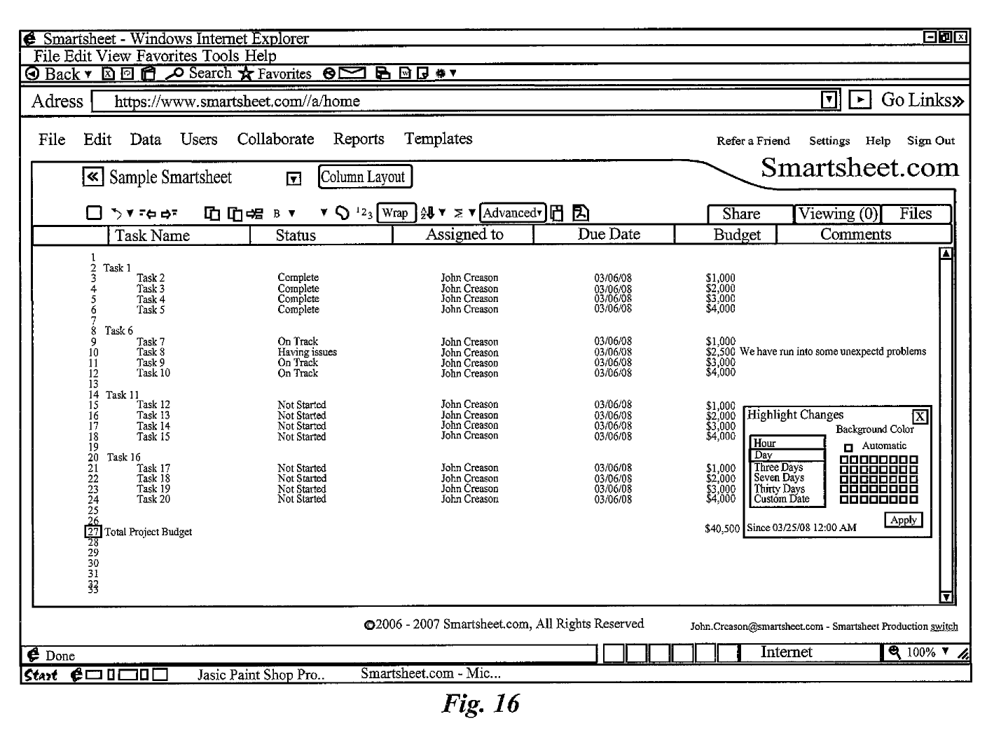

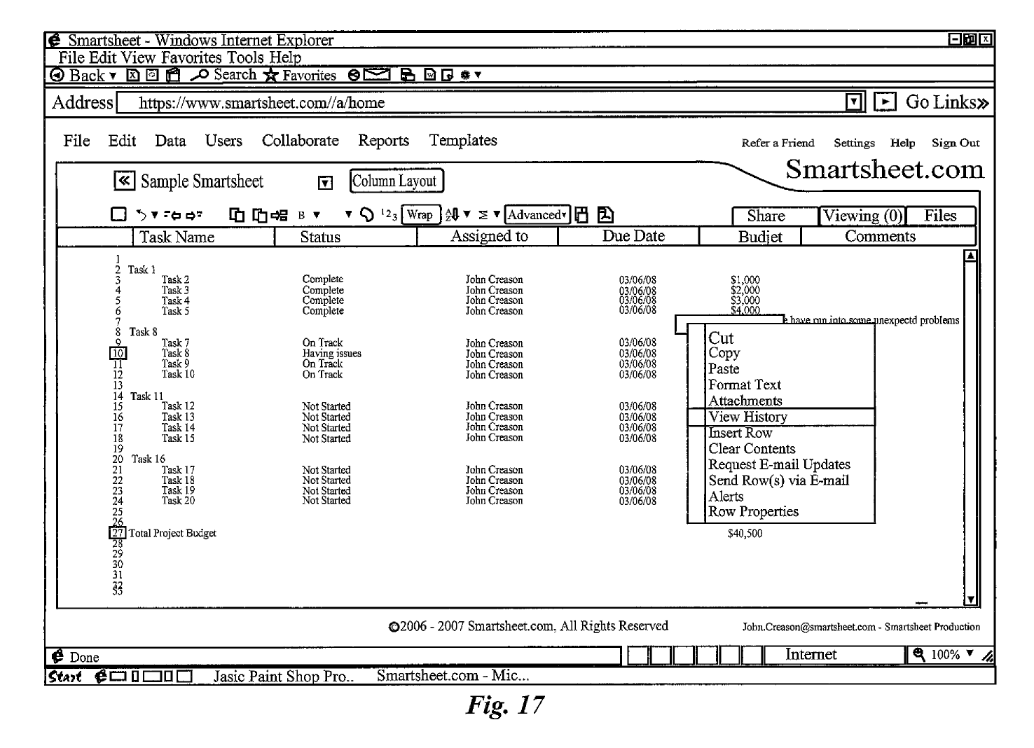

FIG. 15 illustrates the system's ability to highlight fields within a row and column based user interface related to a given field in which the values have changed within a given period of time. In a preferred embodiment the user interface represents a task sheet within the task management system. Further, the user can select from one of several date rages (e.g., 1 day, 3 days, 1 week) as illustrated in FIG. 16. Then by selecting ‘Show History’ from the menu bar or right clicking and selecting from the pop-up menu as illustrated in FIG. 17, fields or tasks that have been changed within the specified time range will be highlighted. This allows the user to quickly identify and evaluate only those elements, which have changed.

Changed elements are identified by highlighting the visual cell within the task sheet. In a preferred embodiment this is accomplished by changing the background color of the element's cell within the task row from white to another unique identifying color, such as yellow, as per the highlighted areas of FIG. 15. In a further preferred embodiment the user may select which color they wish to designate highlighted elements, using a color palette as shown in FIG. 16.

In addition to the above, users are able to provide their own time granularity for which they want the system to provide change history as illustrated in FIG. 16. For example, if a user wants exactly 5 days, instead of the standard 1 week, the user can select 5 days and the system will highlight all task elements that have changed data within that specified time period.

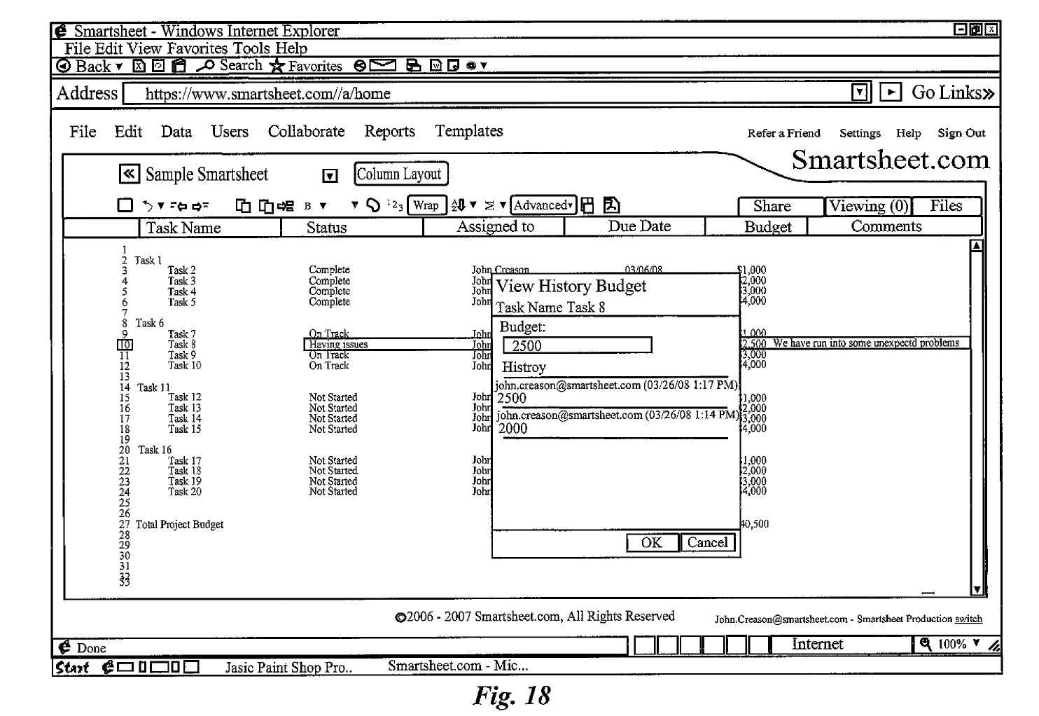

In a preferred embodiment reports can be generated based on the history data as illustrated in FIG. 18. A user can request reports to be generated wherein the user is presented with changes to elements within a period of time. For example, if the status of a Task A was changed from in-progress to complete, the report would generate Task A: Status=Complete.

Other embodiments of the invention will be apparent to those skilled in the art from consideration of the specification and practice of the invention disclosed herein. The specification and examples should be considered exemplary only. In particular, one skilled in the art will recognize this system is not limited to being implemented in a Java-based environment, and any suitable web development environment may be used involving different operating systems (Unix, Linux, Windows, etc.), web servers (Apache, IIS), programming languages/frameworks (Java, ASP.net/Visual Basic/C#, Ruby on Rails, etc.) and databases (MySQL, SQL Server, Oracle, etc.). The scope of the invention is only limited by the claims appended hereto.

What is claimed is:

1. A computer-implemented method for generating an email update request from an initiating client to a recipient account, comprising the steps of:
(a) sending instructions to the initiating client operable for:
(i) presenting a task sheet to the initiating client, the task sheet having at least one task and a set of associated cells;
(ii) receiving an email update request command from the initiating client;
(iii) presenting a user interface configured to enable selection of a subset of the associated cells;
(b) receiving the selected subset of the associated cells;
(c) generating the email update request based on the selected subset of the associated cells; and
(d) transmitting the email update request for update to an email address associated with the recipient account.

2. The computer-implemented method of claim 1, wherein the email update includes a single use authorization key.

3. The computer-implemented method of claim 1, wherein the email update includes a web form.

4. The computer-implemented method of claim 3, wherein the email update includes a single use authorization key.

5. The computer-implemented method of claim 1, wherein the email update includes a link to a web page that is rendered by an email client when the email client request does not support web forms.

6. A computer system configured to manage a task hierarchy, comprising:
a task data store configured to store information about a plurality of tasks, the task information including a parent task and a task unique identifier;
a task sheet data store configured to store information about a plurality of tasks, the task sheet information including a task sheet unique identifier; and
a task to task sheet data store configured to store a plurality of relationships between tasks and task sheets, said relationships including a task unique identifier and a task sheet unique identifier.

7. The computer system of claim 6, wherein a status of a parent task is at least partially determined by the status of a child task.

8. The computer system of claim 6, wherein a characteristic of a child task is at least partially determined by the status of a parent task.

9. A computer-implemented method for managing tasks, comprising:
(a) receiving information for creating a first task sheet;
(b) creating the first task sheet and assigning the first task sheet a unique identifier;
(c) receiving information for creating a first task relating to the first task sheet;
(d) creating the first task and assigning the task a unique identifier;
(e) creating a relationship between the first task sheet and the first task;
(f) receiving information for creating a second task sheet;
(g) creating the second task sheet and assigning the second task sheet a unique identifier; and
(h) creating a relationship between the second task sheet and the first task.

10. The computer-implemented method of claim 9, further comprising:
receiving information for creating a second task relating to the first task sheet;
creating the second task and assigning the second task a unique identifier;
creating a relationship between the first task sheet and the second task;
receiving an instruction to make the second task a child of the first task; and
updating the second task to include the unique identifier of the first task as a parent task identifier.

11. A computer system for managing a plurality of task sheet templates, comprising:
a task sheet data store configured to store information about the plurality of task sheets;
a column definition data store configured to store schema information about a plurality of system defined column types and further configured to receive and store information relating to user defined column types;
a row definition data store configured to store schema information about a plurality of system defined row types and further configured to receive and store information relating to user defined row types; and
a task sheet data store configured to store relationships between task sheets and column and row definitions.

12. A computer system for coordinating information between a client and a server using a client side in-memory database, comprising:
the server comprising:
a server processing unit;
a server memory device;
a server data storage device;
a server program stored in the server data storage device for providing instructions to the server processing unit;
a server database in the server data storage device for managing relational data; and
the server processing unit responsive to the instructions of the server program, operable for:
transmitting database structure instructions to the client;
transmitting initial data to the client; and
receiving data updates from the client;
the client comprising:
a client processing unit;
a client memory device;
a client data storage device;
a web browser program stored in the client data storage device for providing instructions to the client processing unit;
the client processing unit responsive to the instructions of the web browser program, operable for:
creating the client side in-memory database operating within the context of the web process based on the transmitted database structure instructions, the client side in-memory database configured to manage relational data;
populating the client side in-memory database based on the transmitted initial data;
generating a user interface configured to receive user input;
updating data in the client side in-memory database based on input received by the user interface; and
transmitting updated data to the server database.

13. A computer-implemented method for coordinating information between a client and a server using a client side in-memory database comprising:
transmitting database structure instructions from the server to the client;
transmitting initial data from the server to the client;
creating a client side in-memory database operating within the context of the web process based on the transmitted database structure instructions, the in-memory database configured to manage relational data;
populating the client side in-memory database based on the transmitted initial data;
generating, by the web browser, a user interface configured to receive user input;
updating data in the client side in-memory database based on input received by the user interface;
transmitting updated data from the client side in-memory database to the server database; and
selectively updating the data in the server database based on received updated data.
